(19) United States
(12) Patent Application Publication
(10) Pub. No.: US 2016/0287461 A1
(43) Pub. Date: Oct. 6, 2016

(54) SURGICAL TABLE WITH COMBINATION FOOTBOARD AND PATIENT TRANSFER BOARD

(71) Applicant: Michael L. Naughton, Aurora, CO (US)

(72) Inventor: Michael L. Naughton, Aurora, CO (US)

(21) Appl. No.: 14/675,968

(22) Filed: Apr. 1, 2015

(51) Int. Cl. A61G 13/04; A61G 13/10; A61G 13/12

(52) U.S. Cl. CPC A61G 13/04; A61G 13/125; A61G 13/10

(57) ABSTRACT

A surgical table includes a combination footboard and patient transfer board to facilitate more efficient handling of a patient undergoing procedures requiring movement of the patient's lower body toward a perineal cutout portion of the table, and to facilitate more efficient movement of the patient to and from the surgical table. The combination board may be oriented horizontally or vertically and secured to the surgical table by multi-angular rail locks. The combination board includes a frame, a pad, and a pair of extension members secured to a common side of the board. The invention also includes a method of supporting a patient that is transported from a first location to a second location on the surgical table utilizing the combination board.

### FIELD OF THE INVENTION

The invention relates to operating room or surgical tables, and more particularly, to a surgical table that includes a combination footboard and patient transfer board to facilitate more efficient handling of a patient undergoing procedures requiring placement of the patient's lower body at a perineal cutout portion of the table, and to facilitate more efficient movement of the patient to and from the surgical table.

### BACKGROUND OF THE INVENTION

Operating room or surgical tables have developed over time to incorporate increased functionality. A multitude of features and options are now available for many commercially available surgical tables to include powered articulation of discrete sections of the surgical table enabling a patient to be supported in a wide variety of angular positions. For example, surgical tables may include powered adjustment capabilities for the head, torso, and legs of the patient as a patient is positioned on the surgical table. Additionally, surgical tables may include various attachments to extend or shorten an effective length of a particular section of the surgical table to accommodate a caregiver's optimum positioning to operate on the patient and/or to accommodate the particular height of the patient.

Despite the significant number of surgical tables developed over time, one particular disadvantage with these prior art surgical tables is that if the patient needs to be positioned to place the feet in stirrups that are attached to the surgical table for various procedures, the patient must be manually lifted or slid down towards the end of the table. This portion of the table may also be referred to as the “perineal cutout” portion of the table enabling a surgeon the necessary access to the lower torso of the patient during procedures such as a URO or an OB/GYN procedure. This cutout portion of the table is located below the mid-section of the patient as the patient normally lies on the table. More specifically, when the patient is lying in a prone position on the table, the hips and thighs must be supported by the table, thus the perineal cutout must be located beyond the thigh area of the patient towards the feet of the patient. When the patient's feet are placed in stirrups, the patient's hips must be positioned very close to the perineal cutout thus requiring the patient to be lifted and moved towards the perineal cutout. When the patient is initially transferred to the surgical table, this problem cannot be overcome since the patient must initially be placed in a position so the hips and thighs are supported by the table. Therefore, it is not possible to initially locate the patient on the surgical table with the hips in the required location directly adjacent the perineal cutout even when it is known that the patient must be positioned as such for the medical procedure. Many patients cannot physically assist in movement of their body towards the perineal cutout for various reasons (injury, being under anesthesia, etc.). Accordingly, more than one caregiver must be used further complicating efforts to move the patient.

Another general disadvantage associated with many surgical tables is that many such tables comprise separated and removable table sections or pieces that each serve but a single purpose, and cannot be used for other supporting functions. Therefore, a surgical table may require multiple additional sections or pieces to be used for each different surgical procedure to be conducted.

Another disadvantage with many surgical tables is that the removable table sections can be quite heavy and difficult to manipulate without two persons being involved to attach and detach the table sections. Further, many of these table sections are made from carbon fiber to provide full “C-arm coverage,” meaning the table sections are transparent to x-ray imaging so that the patient can be x-rayed without having to move the patient to another table. These carbon fiber table sections can be quite expensive thereby adding significant cost to surgical tables.

Considering the shortcomings of the prior art, the below described invention addresses these shortcomings within an economical and mechanically reliable construction.

### SUMMARY OF THE INVENTION

According to the invention, a surgical table includes a combination footboard and patient transfer board to facilitate more efficient handling of a patient undergoing procedures requiring movement of the patient's lower body toward a perineal cutout portion of the table, and to facilitate more efficient movement of the patient to and from the surgical table. According to the invention, the surgical table includes a torso support portion with a perineal cutout located at an end of the surgical table. The perineal cutout has the u-shaped configuration in which the end of the table has a pair of angled edges that extend towards a torso support section of the table, and a transverse edge interconnects the angled edges. This section of the table may be alternatively defined as having two extensions bisected by the perineal cutout.

The table further includes side rails that are attached to opposite lateral sides of the table. The side rails have one end that is attached at the torso section of the table, and the side rails may extend a desired distance beyond the located at the perineal cutout. A combination footboard and patient transfer board (hereinafter referred to as the “combination board”) is secured to the side rails. In a first position, the combination board may be oriented vertically in which the combination board is secured to the surgical table by a multi-angular lock. In a second position, the combination board may be oriented horizontally in which the combination board is secured to the surgical table by the multi-angular lock.

In the vertical orientation, the combination board serves as a foot stabilization board to prevent the feet of the patient from extending beyond the face of the combination board on which the feet contact. The lower portion of the legs of the patient may extend slightly beyond the edge of the table at the perineal cutout, yet the surgical table still provides adequate support for the patient yet enabling the patient's feet to be contacted and supported by the combination board.

In the horizontal orientation, the combination board serves as a horizontal extension to support the legs and feet of the patient's body. A gap exists between the end of the surgical table at the perineal cutout and the near edge of the combination board. This gap is preferably centered on the area of the patient's knee when the patient is in the prone position. Support is not required to be placed under the patient's knee, and support at the thigh and feet or lower leg is adequate when the patient is being transferred from a gurney or bed to the surgical table. Because the combined length of the gap and combination board can be considered significantly larger than prior art surgical table extensions that abut the edge of the existing surgical table, the combination board is significantly smaller, lighter, and easier to handle.

Furthermore for many surgical procedures, there may not be a need to provide support underneath the patient's knee area at any time when the patient is on the surgical table. Therefore, it is unnecessary to replace the combination board with a standard table extension. Accordingly, the combination board is an economical solution enabling transfer of the patient to and from the surgical table, as well as enabling the combination board to function as a permanent surgical table extension or vertically oriented footboard.

Yet another advantage of the combination board is that the gap located between the end of the table at the perineal cutout and the near edge of the combination board provides easier access to radiological equipment that may be located near the perineal cutout. For example, the radiological equipment may include a movable/portable x-ray unit that is selectively positioned to enable a technician to x-ray the desired location of the patient's body.

In another aspect of the invention, it includes a method to facilitate transfer of the patient from one position, such as when the patient is on a gurney or hospital bed, to another position onto the surgical table of the invention. According to the method, the surgical table includes the combination board, and the patient is moved to the surgical table by the assistance of attending medical personnel. The patient's crotch area is located directly adjacent the perineal cutout section of the surgical table. The patient's feet or lower portions of the legs are supported by the combination board placed in the horizontal position. The combination board may be adjusted in terms of its specific distance from the facing end of the surgical table to account for the particular length of the patient when in the supine position. Thus, the gap between the end of the surgical table and combination board is variable.

According to another aspect of the invention with respect to the method, stirrups or other supporting components can be attached to the surgical table, the legs of the patient are lifted to be placed within the stirrups, and the combination board is removed. The patient does not have to be shifted either direction along the longitudinal length of the surgical table thereby enabling the patient to be immediately placed in a position for a subsequent surgical procedure.

According to yet another aspect of the invention with respect to the method, the combination board may remain in its horizontal orientation for support of the feet and/or lower legs of the patient for another type of surgical procedure that does not require stirrups.

To facilitate attachment of the combination board in a vertical orientation, a multi-angular rail lock is provided on each of extension member that protrudes from one side of the combination board. The locks have a receiving slot that can be adjusted to receive the corresponding horizontally extending side rail. The locks are tightened against the rail to secure the combination board in the vertical position.

To facilitate attachment of the combination board in the horizontal orientation, the multi-angular rail locks are adjusted so that each receiving slot is rotated 90 degrees to receive the side rails. The free ends of the extension members are first inserted in corresponding spaced holes located at the end of the table. Each rail lock is secured to its corresponding side rail and tightened. The multi-angular rail locks enable the combination board to be placed in either a horizontal or vertical orientation in which the relatively small and maneuverable combination board can be handled by only one person.

In summary, the combination board of the invention can be sized as a much smaller surgical table extension as compared to existing surgical table extensions that extend continuously from the adjacent table section to which it is attached. Because of the smaller size, the combination board of the invention is more easily manipulated by a user, and two persons are not required for attaching or detaching the combination board. Also, the combination board is a much more economical table extension since the combination board does not have to be made from a large piece of carbon fiber.

Considering this summary of the invention, in one aspect, the invention may be considered a surgical table comprising: (i) a frame; (ii) a base; (iii) a pedestal mounted on the base and supporting said frame; (iv) a torso portion connected to said frame; (v) at least one side rail mounted to said frame or said torso portion; (vi) a head portion connected to said frame and horizontally spaced from said torso portion; (vii) a perineal cutout portion formed at an end of said table adjacent said torso portion and opposite said head portion, said perineal cutout portion including an opening defined between spaced angled edges and a transverse edge interconnecting adjacent ends of said angled edges; (viii) a combination board removably attached to the end of the table at said perineal cutout portion, said combination board including a pair of extension members attached to a side of said combination board; and (ix) a multi-angular rail lock attached to each extension member.

According to another aspect of the invention, it may be considered a method of supporting a patient that is transported from a first location to a second location on a surgical table, said method comprising: (a) supporting the patient in a horizontal position from the first location; (b) moving the patient from the first location to the second location on the surgical table, the surgical table having: (i) a torso supporting portion to support the torso of the patient, (ii) a perineal cutout portion formed at an end of said table adjacent said torso supporting portion (iii) a combination board removably attached to the end of the table at the perineal cutout portion, the combination board including a pair of extension members attached to and extending away from a common side of the combination board; and (c) orienting the patient such that the patient's crotch area is located directly adjacent or at the perineal cutout portion, and the patient's legs and feet extend beyond the torso supporting portion such that the feet, or the lower legs and feet, are supported by the combination board; and wherein a gap exists between an end of the surgical table at the perineal cutout and a facing surface of the combination board such that a portion of the patient's legs span the gap.

Further according to this second aspect of the invention, the combination board may extend horizontally such that the feet, or the lower legs and feet of the patient rest on the combination board. Yet further according to this second aspect of the invention, said combination board may extend vertically, such that lower surfaces of the feet of the patient rest against the combination board. Yet further according to this second aspect of the invention, the patient may be oriented such that said patient does not have to be moved longitudinally towards said perineal cutout when said patient undergoes a procedure in which the patient's legs are raised above a level of said torso supporting position. Yet further according to this second aspect of the invention, the procedure may include a procedure conducted at or near a crotch area of the patient in which an attending surgeon is located near the patient at the perineal cutout portion.

According to yet another aspect of the invention, it may be considered a sub-combination comprising: (i) a frame; (ii) a pad mounted to said frame; (iii) a pair of extension members mounted to a common said of said frame, said extension members being spaced from one another and extending substantially parallel to one another, each extension member having a free end that extends away from said common side of said frame; and (iv) a multi-angular rail lock attached to each extension member.

Other features and advantage of the invention will become apparent from a review of the following detailed description taken in conjunction with the drawings.

### BRIEF DESCRIPTION OF THE DRAWINGS

FIG. 1 is an exploded perspective view of the surgical table of the invention including the combination board placed in the vertical orientation;

FIG. 2 is a perspective view of the surgical table with the combination board attached in the vertical orientation;

FIG. 2A is a greatly enlarged fragmentary perspective view of a portion of FIG. 2 showing details of a multi-angular rail lock as it is attached to a side rail of the surgical table for placement of the combination board in the vertical orientation;

FIG. 3 is a side elevation view of the surgical table showing the combination board attached in the vertical orientation, and showing a patient lying on the table with the feet of the patient contacting the combination board;

FIG. 4 is another exploded perspective view of the surgical table showing the combination board placed in the horizontal orientation;

FIG. 5 is a perspective view of the surgical table with the combination board attached in the horizontal orientation;

FIG. 5A is a greatly enlarged fragmentary perspective view of a portion of FIG. 5 showing further details of the multi-angular rail lock as it is attached to a side rail of the surgical table in the horizontal orientation; and

FIG. 6 is a side elevation view of the surgical table showing the combination board attached in the horizontal orientation, and illustrating a patient lying on the table with the feet of the patient supported by the combination board, and a gap located between the patient's thighs and feet.

### DETAILED DESCRIPTION

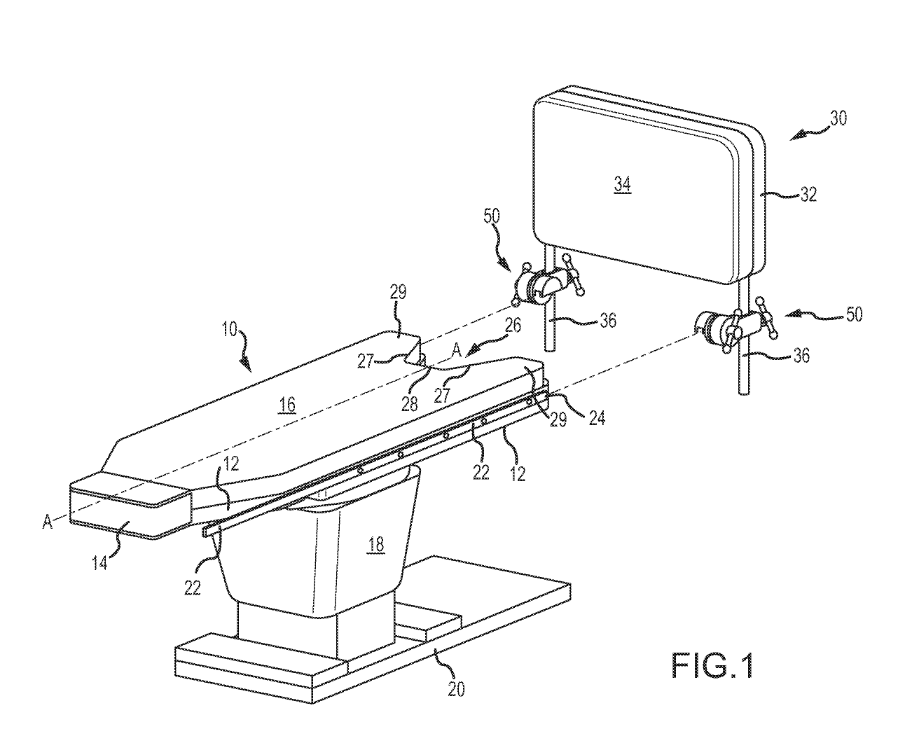

Referring to FIG. 1, the surgical table 10 is shown, along with the combination board 30 placed in the vertical orientation. The surgical table 10 comprises a pedestal 18 and a base 20. A frame 12 of the table is supported by the pedestal 18. The interior of the pedestal 18 may power components and other components (not shown) of the table for manipulating the positioning of the torso support portion 16. The table 10 is also shown as having a head support portion 14 that extends beyond the torso support portion 16. The head support portion 14 may be a removable element. Shorter patients may not require the head support portion 14. The table has a length that extends along the longitudinal axis A-A. The table is symmetrical about this longitudinal axis as shown.

The perineal cutout 26 is characterized by a pair of angled edges 27 that extend towards the central area of the torso support portion 16. A transverse edge 28 interconnects the angled edges 27. Alternatively, the perineal cutout 26 may be characterized as a gap that bisects a longitudinal axis A-A of the table, and table extensions 29 residing on both sides of the gap. Side rails 22 attached to opposite lateral sides of the table 10 as shown. The side rails extend substantially horizontal. One end of each of the side rails 22 extends beyond the table 10, terminating at free end 24.

The combination board 30 includes a frame 32 and a pad 34. The thickness of the pad 34 may be selected to match the elevation of the upper surface of the torso support portion 16. As also shown, the combination board 30 includes two extension members 36 that each extend from one side edge of the combination board 30. A multi-angular rail lock 50 is attached to each extension member 36.

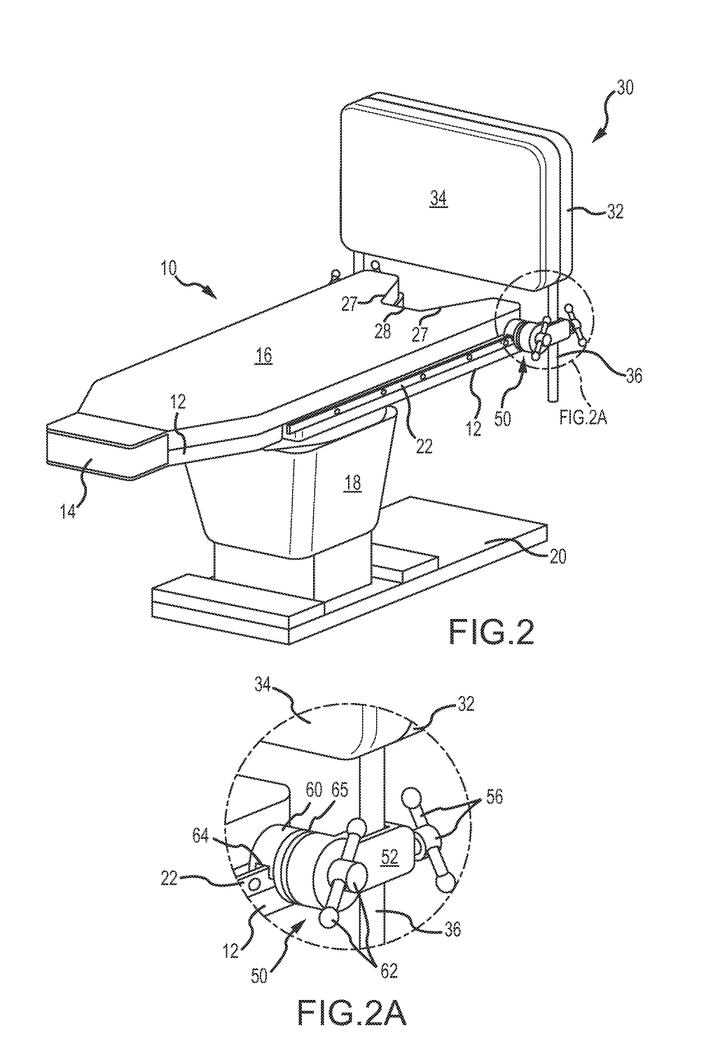

Referring also to FIGS. 2 and 2A, the combination board 30 is shown attached to the side rails 22. Referring specifically to FIG. 2A, details are shown for the multi-angular rail lock 50 in which the rail lock comprises two holding or locking features including a first lock housing 52 with a channel or slot 54 extending through the housing 52. This first lock housing 52 is used to attach the lock to the corresponding extension member 36. The end of the extension member is placed through the opening in the housing 52. A locking pin with handle 56 is used to tighten the lock housing 52 against the extension member 36 in which the pin protrudes into the opening of the housing to contact the extension member therein. A second lock housing 60 of the multi-angular rail lock 50 is used to attach it to the side rail 22, in which the housing 60 includes a slot or groove 64 that receive the side rail 22. Another locking pin with handle 62 is used to tighten the lock 50 against the side rail 22. Accordingly, the combination board 30 can be locked in place at any desired location along the exposed length of the side rail 22. In order to orient the multi-angular rail lock 50 in the desired angular position, the housing 60 can be rotated with respect to the remaining part of the lock by a plurality of matching pairs of teeth/protrusions (not shown) located at the interface 65 between the housing 60 and the remaining part of the lock 50.

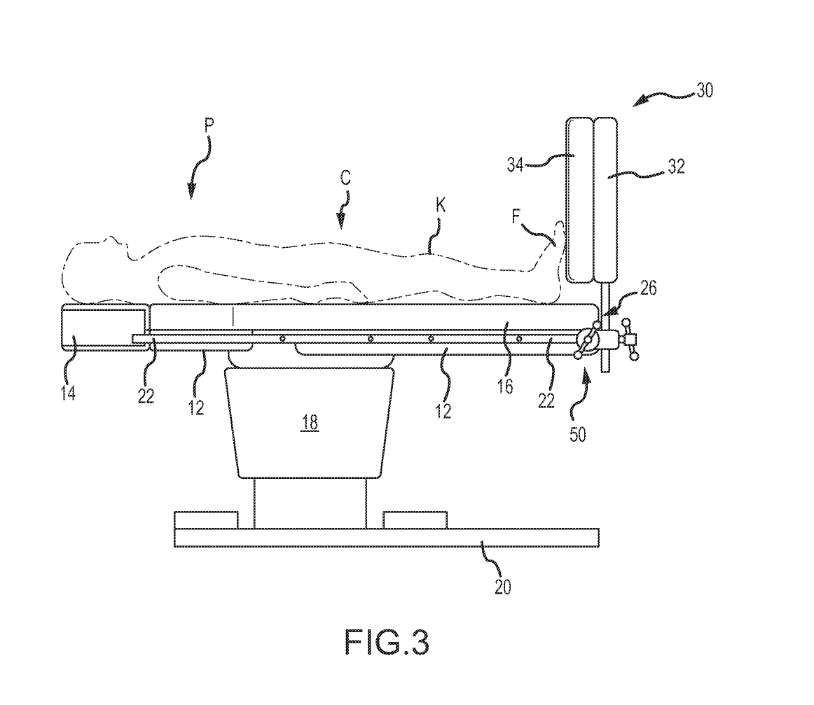

Referring to FIG. 3, the combination board 30 is shown in which the patient's feet F are either very close to or in contact with the pad 34. The patient P in FIG. 3 is therefore adequately constrained and supported for whatever surgical procedure may be required in which the patient's feet are provided with adequate constraint/support.

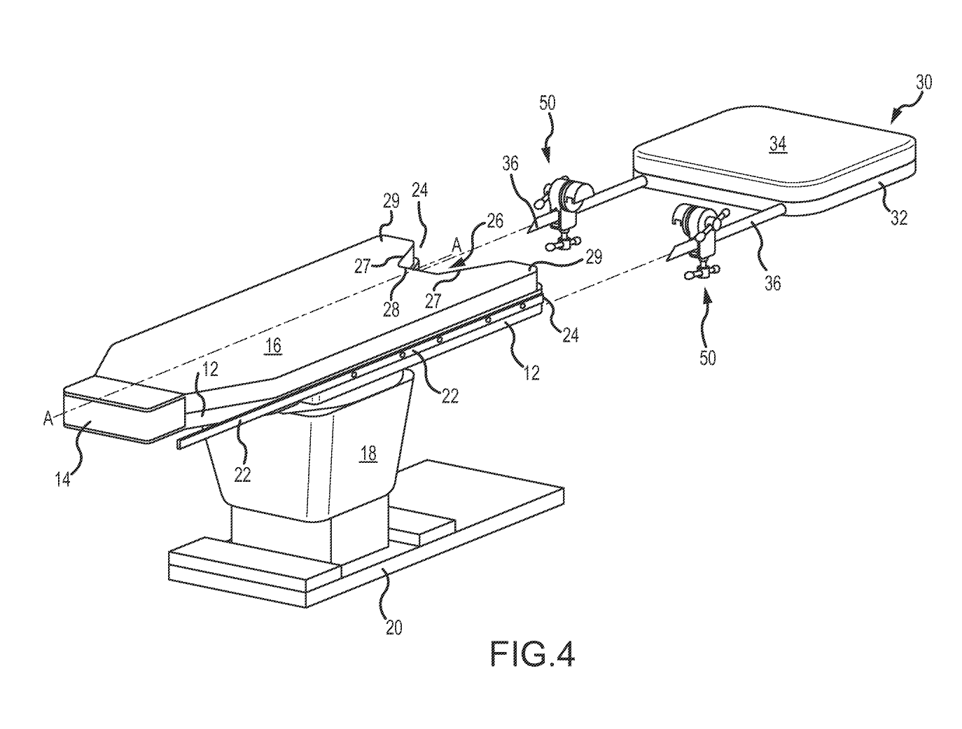

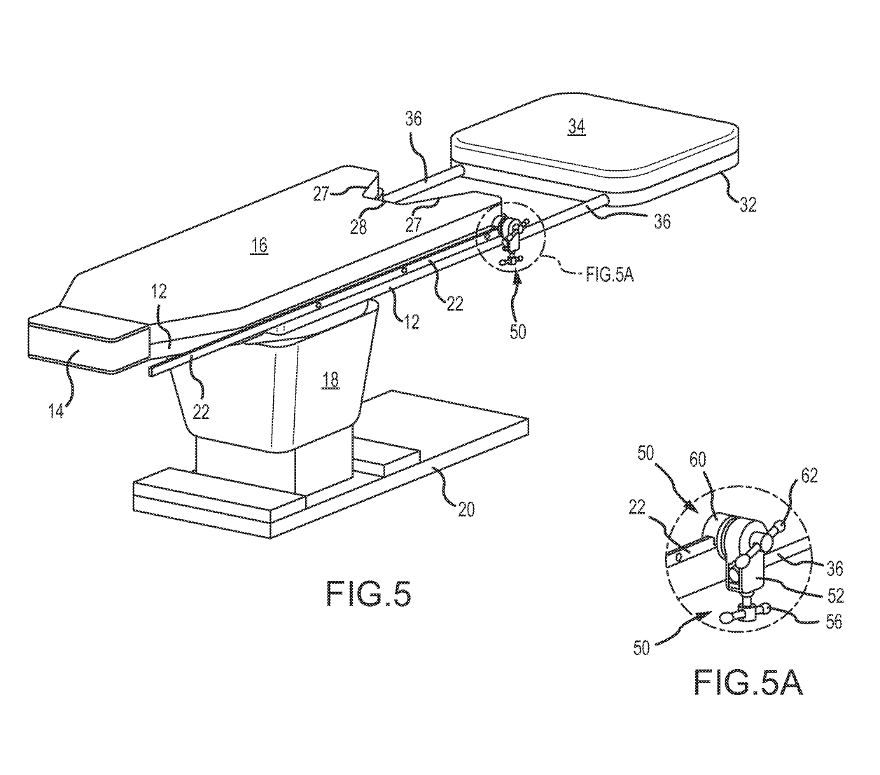

Referring to FIG. 4, the combination board 30 is shown in the horizontal orientation. Referring also to FIGS. 5 and 5A, the free ends of the extension members 36 are inserted in corresponding holes (not shown) in the end of the frame 12. The multi-angular rail locks 50 are secured to lock and hold the combination board 30 in place so there is a desired spacing between the end of the table 10 and the facing surface of the combination board 30. The housing 60 on each lock 50 is rotated 90 degrees so that the slot 64 of the housing 60 is oriented to receive the horizontally extending rails 22. The handles 62 are again tightened to secure the combination board 30 in place.

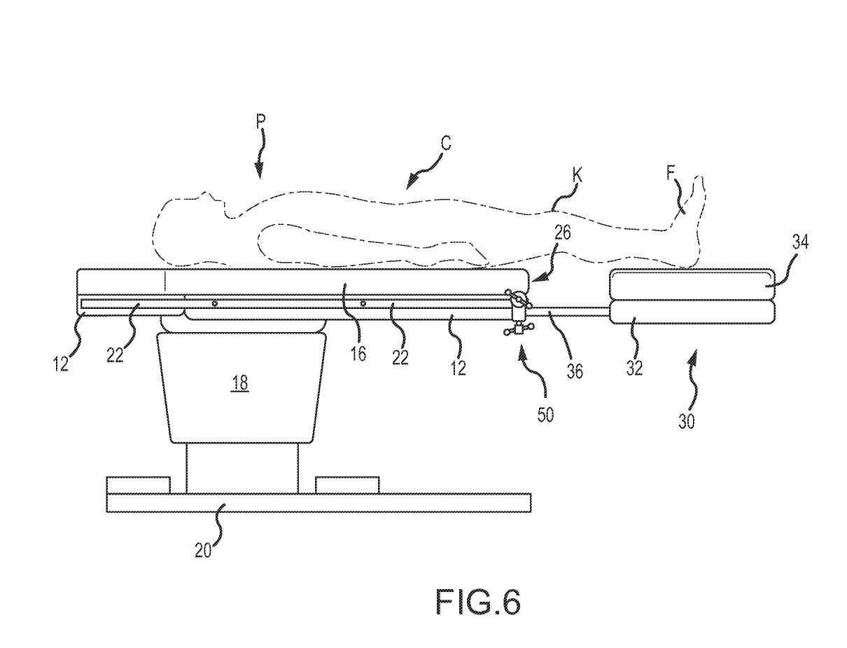

Referring to FIG. 6, the patient P is shown in the supine position, with the knee area K approximately centered over the gap between the end of the table and the facing surface of the combination board 30. As can be appreciated, this gap still allows for adequate support of the patient's lower body since the feet F and/or lower portion of the legs are stabilized on the pad 34, yet the combination board is not required to be placed against the end of the table. This configuration with the gap allows the combination board to be of significantly smaller size in terms of the frame and pad of the combination board. Accordingly, traditionally large and continuous table extensions made of carbon for extending the “C-arm” of the surgical table can be avoided. This aspect of the invention provides an advantage not only in ease of handling the combination board, but also saves in overall cost of the surgical table. This gap may also allow for additional room to manipulate and access portable radiological equipment (not shown) that may be located under the surgical table. FIG. 6 also shows the head support portion 14 of the table removed, which is optional depending upon the particular height of the patient.

According to one method of the invention, the method facilitates transfer of the patient from one position, such as when the patient is on a gurney or hospital bed, to another position onto the surgical table of the invention. According to this method, the surgical table is placed with the combination board placed in the horizontal orientation of FIG. 6. The patient is moved from to the surgical table by the assistance of attending medical personnel (not shown). The patient's crotch area C is located directly adjacent the perineal cutout section 26 of the surgical table. The patient's feet F or lower portions of the legs are supported by the combination board as shown. The knees K of the patient are generally centered in the gap between the combination board 30 and the end of the table 10 at the cutout section 26. The combination board may be adjusted in terms of its specific distance from the facing end of the surgical table to account for the particular length of the patient when in the supine position.

According to another method of the invention, stirrups or other supporting components (not shown) are attached to the surgical table, the legs of the patient are directly lifted to be placed within the stirrups, and the combination board is removed (see FIG. 4). According to this second method, the patient does not have to be shifted either direction along the longitudinal length of the surgical table, thereby enabling the patient to be immediately placed in a position for a subsequent surgical procedure.

The invention is described with respect to preferred embodiments. However, it shall be understood that the invention may be modified or adjusted commensurate with the scope of the claims appended hereto. Therefore, the preferred embodiments shown and described shall not be interpreted as strictly limiting the scope of the invention.

1. A surgical table comprising:
a frame;
a base;
a pedestal mounted on the base and supporting said frame;
a torso portion connected to said frame;
two side rails, one side rail being mounted on each opposite lateral side of said table;
a head portion connected to said frame and horizontally spaced from said torso portion;
a perineal cutout portion defining a gap at an end of said table adjacent said torso portion and opposite said head portion, said perineal cutout portion defined between spaced angled edges and a transverse edge interconnecting adjacent ends of said angled edges;
a combination board removably attached to the end of the table at said perineal cutout portion, said combination board including a pair of extension members attached to a side of said combination board, said extension members having free ends inserted within corresponding spaced holes located at an end of the table at said perineal cutout, and wherein a gap exists between an end of the surgical table at the perineal cutout and a facing surface of said combination board when the combination board is placed in a horizontal orientation;
a multi-angular rail lock attached to at least one of said extension members; said combination board being movable from the horizontal orientation to a vertical orientation by removal of the free ends of the extension members from within the spaced holes, and rotating the combination board in which said multi-angular lock has a housing portion thereof also rotated to accommodate movement to the vertical orientation, and wherein the free ends of the extension members are oriented substantially vertically and located below a level of said frame and above a level of said base.

2. A surgical table, as claimed in claim 1, wherein:
said multi-angular rail lock includes a lock housing, and a channel extending through said lock housing, said channel oriented substantially horizontal so said channel may be aligned to receive said at least one rail.

3. A surgical table, as claimed in claim 1, wherein:
said multi-angular rail lock is located in said gap between said end of the surgical table at the perineal cutout and said facing surface of said combination board.

4. A surgical table, as claimed in claim 3, wherein:
said multi-angular rail lock is substantially horizontally aligned with said combination board and said torso portion.

5-6. (canceled)

7. A surgical table, as claimed in claim 1, wherein:
said combination board further includes a frame and a pad mounted to said frame.

8. A method of supporting a patient that is transported from a first location to a second location on a surgical table, said method comprising:
supporting the patient in a horizontal position from the first location;
moving the patient from the first location to the second location on the surgical table, the surgical table having:
(i) a torso supporting portion to support the torso of the patient, (ii) a perineal cutout portion formed at an end of said table adjacent said torso supporting portion (iii) a combination board removably attached to the end of the table at the perineal cutout portion, the combination board including a pair of extension members attached to and extending away from a common side of the combination board;
orienting the patient such that the patient's crotch area is located directly adjacent the perineal cutout portion, and the patient's legs and feet extend beyond the torso supporting portion such that the feet, or the lower legs and feet, are supported by the combination board; and
wherein a gap exists between an end of the surgical table at the perineal cutout and a facing surface of the combination board such that a portion of the patient's legs span the gap.

9. A method, as claimed in claim 8, wherein:
said combination board extends horizontally such that the feet, or the lower legs and feet of the patient, rest on the combination board.

10. A method, as claimed in claim 8, further including:
moving the combination board from the horizontal orientation to a vertical orientation so said combination board extends vertically by detaching the combination board from the surgical table, adjusting an multi-angular rail lock that interconnects the combination board to the surgical table, and reattaching the combination board to the surgical table.

11. A method, as claimed in claim 8, wherein:
said patient is oriented such that said patient does not have to be moved longitudinally towards said perineal cutout when said patient undergoes a procedure in which the patient's legs are raised above a level of said torso supporting position.

12. A method, as claimed in claim 8, wherein:
said procedure includes one conducted near a crotch area of the patient in which an attending surgeon is located near the patient at the perineal cutout portion.

13-14. (canceled)
